(19) United States
(12) Patent Application Publication
(10) Pub. No.: US 2023/0374240 A1
(43) Pub. Date: Nov. 23, 2023

(54) FOAM SHEET

(71) Applicant: SEKISUI CHEMICAL CO., LTD., Osaka (JP)

(72) Inventor: Masahiro HAMADA, Shiraoka-shi, Saitama (JP)

(73) Assignee: SEKISUI CHEMICAL CO., LTD., Osaka (JP)

(21) Appl. No.: 18/029,248

(22) PCT Filed: Sep. 29, 2021
(86) PCT No.: PCT/JP2021/036021

§ 371 Date: Mar. 29, 2023

(30) Foreign Application Priority Data
Oct. 1, 2020 (JP) 2020-167362
Oct. 1, 2020 (JP) 2020-167363
Oct. 1, 2020 (JP) 2020-167364

(51) Int. Cl. C08J 9/00; C08J 9/10; C08L 23/08; C08L 25/06; C08J 5/18; C09J 7/38

(52) U.S. Cl. CPC C08J 9/0061; C08J 9/103; C08L 23/0815; C08L 25/06; C08J 5/18; C09J 7/381; C08J 2205/052; C08J 2205/02; C08J 2323/08; C08J 2325/06; C08L 2207/04; C08L 2207/066; C08J 2203/04; C09J 2301/302

(57) ABSTRACT

A foam sheet having at least one glass transition temperature (Tg) of 0 to 40° C., a peak value of the loss tangent (tanδ) in the glass transition temperature (Tg) of 0.30 or more, and a 25% compressive strength of 1000 kPa or less, and further having a glass transition temperature (Tg) of −40° C. or less. A foam sheet having cushioning properties and vibration resistance in which no cracking occurs even when used in cold areas can be provided.

### TECHNICAL FIELD

The present invention relates to a foam sheet, for example, to a foam sheet used for cushioning materials for displays or the like.

### BACKGROUND ART

In mobile electronic devices such as notebook personal computers, mobile phones, smartphones, and tablets, a display device may have a cushioning material disposed on the back side thereof in order to prevent damage or failure. The cushioning material is required to have high flexibility, and a foam sheet has been conventionally widely used.

The foam sheet may be used, for example, as a pressure-sensitive adhesive tape by applying a pressure-sensitive adhesive on at least one surface inside an electronic device. Conventionally, as a foam sheet used in these applications, a crosslinked polyolefin resin foam sheet that is obtained by foaming and crosslinking a foamable polyolefin resin sheet containing a thermally decomposable foaming agent is known (for example, see PTL 1).

Further, an acrylic foam, for example, has been proposed as a material with high impact resistance (see PTL 2).

### CITATION LIST

### Patent Literature

PTL1: JP 2014-28925 A

PTL2: JP 2012-519750 T

### SUMMARY OF INVENTION

### Technical Problem

In recent years, as electronic devices have become more sophisticated, the acoustic functions of mobile electronic devices such as smartphones have improved. As a result, there is a problem of increased vibration in mobile electronic devices, and this problem is particularly remarkable when a glass or polycarbonate material is used for a back cover for wireless power supply. Specifically, a foam sheet is used as a cushioning material in order to provide cushioning properties between a battery and a back glass or the like, and the foam sheet is required to have a vibration resistance action (vibration resistance).

In order to solve the aforementioned problem, a method of using a material having a glass transition temperature (Tg) around normal temperature (0 to 40° C.), that is, having a tanδ peak around normal temperature is conceivable.

However, a material having a Tg or tanδ at 0 to 40° C. is assumed to have poor flexibility when used in cold areas, and there is concern about cracking of the foam.

Therefore, it is an object of the present invention to provide a foam sheet having vibration resistance in which no cracking occurs even when used in cold areas, in addition to cushioning properties conventionally required for foams.

Further, 5G smartphones are being promoted, and foam sheets are also required to have low dielectric constant, in order to suppress communication delays.

Accordingly, it is an object of the present invention to provide a foam sheet having vibration resistance and low dielectric constant, in addition to cushioning properties conventionally required for foams.

Further, in addition to the problem of vibration resistance, there is also a problem of water vapor entering mobile electronic devices such as smartphones. Since water vapor leads to failure of electronic components, countermeasures against it are also required. As a base material expected to have a vibration resistance effect, there is the acrylic foam disclosed in PTL 2. However, the acrylic foam can be expected to have a vibration resistance effect but has a disadvantage of high water vapor permeability. Accordingly, there is a demand for a material that satisfies both vibration resistance and water vapor permeability.

Therefore, it is an object of the present invention to provide a foam sheet having a vibration resistance action and moisture permeation resistance, in addition to cushioning properties conventionally required for foams.

### Solution to Problem

As a result of diligent studies, the inventors have found that the aforementioned problem can be solved by having two or more glass transition temperatures (Tg), and setting each of the glass transition temperatures, loss tangent (tanδ), and compressive strength to a value falling within a certain range, thereby accomplishing the present invention (first invention).

Further, they have found that the aforementioned problem can be solved by setting each of the glass transition temperature (Tg), loss tangent (tanδ), and compressive strength to a value falling within a certain range, and setting the water vapor transmission rate to a certain value or less, thereby accomplishing the present invention (second invention).

Further, they have found that the aforementioned problem can be solved by setting each of the glass transition temperature (Tg), loss tangent (tanδ), compressive strength to a value falling within a certain range, and setting the relative dielectric constant to a certain value or less, thereby accomplishing the present invention (third invention).

That is, the present invention provides [1] to [19] below.

[1] A foam sheet having at least one glass transition temperature (Tg1) of 0 to 40° C., a peak value of the loss tangent (tanδ) at the glass transition temperature (Tg1) of 0.30 or more, and a 25% compressive strength of 1000 kPa or less, and further having a glass transition temperature (Tg2) of −40° C. or less.

[2] A foam sheet having a glass transition temperature (Tg) of 0 to 40° C., a peak value of the loss tangent (tanδ) of 0.30 or more, a 25% compressive strength of 1000 kPa or less, and a water vapor transmission rate (WVTR) of 400 g/m²day or less.

[3] A foam sheet having at least one glass transition temperature (Tg1) of 0 to 40° C., a peak value of the loss tangent (tanδ) at the glass transition temperature (Tg1) of 0.30 or more, a 25% compressive strength of 1000 kPa or less, and a relative dielectric constant of 2 or less.

[4] The foam sheet according to any one of [1] to [3] above, having a 25% compressive strength of 800 kPa or less.

[5] The foam sheet according to any one of [1] to [4] above, having a thickness of 0.03 to 2 mm.

[6] The foam sheet according to any one of [1] to [5], having a strength at break at 23° C. of 5 N/10 mm or more.

[7] The foam sheet according to any one of [1] to [6] above, having a closed cell ratio of 80% or more.

[8] The foam sheet according to any one of [1] to [7] above, having an average cell size of 20 to 400 μm.

[9] The foam sheet according to any one of [1] to [8] above, having a gel fraction of 30 to 80 mass %.

[10] The foam sheet according to any one of [1] to [9] above, having an apparent density of 0.05 to 0.70 g/cm³.

[11] The foam sheet according to any one of [1] and [3] to [8] above, having a water vapor transmission rate (WVTR) of 400 g/m²day or less.

[12] The foam sheet according to any one of [1], [2], and [4] to [11] above, having a relative dielectric constant of 2 or less.

[13] The foam sheet according to any one of [2] to [12] above, having a glass transition temperature (Tg2) present at −40° C. or less.

[14] The foam sheet according to any one of [1] to [13] above, having an elongation at break at 23° C. of 200% or more.

[15] The foam sheet according to any one of [1] to [14] above, wherein a resin constituting the foam sheet comprises a polyolefin resin.

[16] The foam sheet according to [15], wherein the resin constituting the foam sheet further comprises an elastomer.

[17] The foam sheet according to [16], wherein a mass ratio of the elastomer to the polyolefin resin is 90:10 to 15:85.

[18] A pressure-sensitive adhesive tape comprising the foam sheet according to any one of [1] to [17] above, and a pressure-sensitive adhesive material provided on at least one surface of the foam sheet.

[19] A roll composed of the foam sheet according to any one of [1] to [17] above.

### Advantageous Effects of Invention

The present invention can provide a foam sheet having excellent vibration resistance and flexibility in which no cracking occurs even in cold areas, in addition to cushioning properties. Further, the present invention can provide a foam sheet having both vibration resistance action and low water vapor transmission rate, in addition to cushioning properties. Further, the present invention can provide a foam sheet having both vibration resistance and low dielectric constant, in addition to cushioning properties.

### DESCRIPTION OF EMBODIMENTS

Hereinafter, the foam sheet of the present invention will be described more in detail.

### [Foam Sheet]

The foam sheet of the present invention has at least one glass transition temperature (which may be hereinafter referred to as “Tg”) of 0 to 40° C., a peak value of the loss tangent (tanδ) in the glass transition temperature (Tg1) of 0.30 or more, and a 25% compressive strength of 1000 kPa or less, and further has a glass transition temperature (Tg2) of −40° C. or less (first invention).

Further, the foam sheet of the present invention has a glass transition temperature (Tg) of 0 to 40° C., a peak value of the loss tangent (tanδ) of 0.30 or more, a 25% compressive strength of 1000 kPa or less, and a water vapor transmission rate (WVTR) of 400 g/m²day or less (second invention).

Further, the foam sheet of the present invention has at least one glass transition temperature (which may be hereinafter referred to as “Tg”) of 0 to 40° C., a peak value of the loss tangent (tanδ) in the glass transition temperature (Tg1) of 0.30 or more, a 25% compressive strength of 1000 kPa or less, and a relative dielectric constant of 2 or less (third invention).

Incidentally, the term “the present invention” simply refers to the first, second, and third inventions as a whole.

[Glass Transition Temperature and Loss Tangent]

The foam sheet of the present invention (first invention) has at least one glass transition temperature (Tg1) in the range of 0 to 40° C. and a peak value of the loss tangent (tanδ) in the Tg of 0.30 or more. When Tg and tanδfall within such ranges, the foam sheet of the present invention (first invention) exhibits excellent vibration resistance. In the present invention (first invention), the temperature at the peak top of the loss tangent (tanδ) obtained by viscoelasticity measurement is referred to as Tg. In this description, Tg in the range of 0 to 40° C. may be referred to as Tg1.

Tanδ is a ratio (G″/G′) of loss shearing elastic modulus (G″) to storage shearing elastic modulus (G′) and is an index indicating how much energy a material absorbs (turns into heat) when the material deforms. Having a glass transition temperature (Tg1) in the range of 0 to 40° C. that is close to normal temperature and a peak value of tanδin the glass transition temperature of 0.30 or more, the foam sheet of the present invention (first invention) can improve the energy loss in a low frequency band and exhibits excellent vibration resistance effect, as a result. From the above viewpoints, the peak value of tanδ is preferably 0.35 or more, more preferably 0.37 or more, further preferably 0.39 or more, particularly preferably 0.40 or more.

The glass transition temperature (Tg) and loss tangent (tanδ) are values measured by the methods described in Examples.

Further, the foam sheet of the present invention (first invention) further has a glass transition temperature (Tg2) of −40° C. or less. A flexibility can be secured even in cold areas, and cracking of the foam sheet can be prevented by having a Tg of −40° C. or less. As used herein, a Tg of −40° C. or less may be referred to as Tg2. Tg2 is more preferably −60° C. or less, further preferably −80° C. or less.

The lower limit of Tg2 is not particularly limited but is preferably −150° C. or more, more preferably −140° C. or more, further preferably −130° C. or more.

The foam sheet of the present invention (second invention) has a glass transition temperature (Tg) in the range of 0 to 40° C. and a peak value of the loss tangent (tanδ) of 0.30 or more. When Tg and tanδ fall within such ranges, the foam sheet of the present invention (second invention) exhibits excellent vibration resistance. In the present invention (second invention), the temperature at the peak top of the loss tangent (tanδ) obtained by viscoelasticity measurement is referred to as Tg. In this description, Tg in the range of 0 to 40° C. may be referred to as Tg1.

Tanδ is a ratio (G″/G′) of loss shearing elastic modulus (G″) to storage shearing elastic modulus (G′) and is an index indicating how much energy a material absorbs (turns into heat) when the material deforms. Having a glass transition temperature (Tg1) in the range of 0 to 40° C. that is close to normal temperature and a peak value of tanδ in the glass transition temperature of 0.30 or more, the foam sheet of the present invention (second invention) can improve the energy loss in a low frequency band and exhibits excellent vibration resistance effect, as a result. From the above viewpoints, the peak value of tanδis preferably 0.35 or more, more preferably 0.37 or more, further preferably 0.39 or more, particularly preferably 0.40 or more.

The glass transition temperature (Tg) and loss tangent (tanδ) are values measured by the methods described in Examples.

Here, in the case where Tg is observed at two points or more, the Tg at at least one point may fall within the range of 0 to 40° C., and the peak value of tanδin the Tg may fall within the aforementioned range.

Further, the foam sheet of the present invention (second invention) preferably also has a glass transition temperature of −40° C. or less. A flexibility can be secured even in cold areas, and cracking of the foam sheet can be prevented by having a Tg of −40° C. or less. As used herein, a Tg of −40° C. or less may be referred to as Tg2. Tg2 is more preferably −60° C. or less, further preferably −80° C. or less.

The lower limit of Tg2 is not particularly limited but is preferably −150° C. or more, more preferably −140° C. or more, further preferably −130° C. or more.

The foam sheet of the present invention (third invention) has at least one glass transition temperature (Tg1) in the range of 0 to 40° C. and a peak value of the loss tangent (tanδ) in the Tg1 of 0.30 or more. When Tg1 and tanδ fall within such ranges, the foam sheet of the present invention (third invention) exhibits excellent vibration resistance. In the present invention (third invention), the temperature at the peak top of the loss tangent (tanδ) obtained by viscoelasticity measurement is referred to as Tg. In this description, Tg in the range of 0 to 40° C. may be referred to as Tg1.

Tanδ is a ratio (G″IG′) of loss shearing elastic modulus (G″) to storage shearing elastic modulus (G′) and is an index indicating how much energy a material absorbs (turns into heat) when the material deforms. Having a glass transition temperature (Tg1) in the range of 0 to 40° C. that is close to normal temperature and a peak value of tanδin the glass transition temperature of 0.30 or more, the foam sheet of the present invention (third invention) can improve the energy loss in a low frequency band and exhibits excellent vibration resistance effect, as a result. From the above viewpoints, the peak value of tanδ is preferably 0.35 or more, more preferably 0.37 or more, further preferably 0.39 or more, particularly preferably 0.40 or more.

The glass transition temperature (Tg) and loss tangent (tanδ) are values measured by the methods described in Examples.

Here, in the case where Tg is observed at two points or more, the Tg at at least one point may fall within the range of 0 to 40° C., and the peak value of tanδin the Tg may fall within the aforementioned range.

Further, the foam sheet of the present invention (third invention) preferably also has a glass transition temperature of −40° C. or less. A flexibility can be secured even in cold areas, and cracking of the foam sheet can be prevented by having a Tg of −40° C. or less. As used herein, a Tg of −40° C. or less may be referred to as Tg2. Tg2 is more preferably −60° C. or less, further preferably −80° C. or less.

The lower limit of Tg2 is not particularly limited but is preferably −150° C. or more, more preferably −140° C. or more, further preferably −130° C. or more.

[Compressive Strength]

The foam sheet of the present invention has a 25% compressive strength of 1000 kPa or less. When the compressive strength exceeds 1000 kPa, the flexibility is insufficient, and damage may occur to internal members of mobile electronic devices. Further, the followability is poor due to insufficient flexibility, and for example, when used as a tape base material, the adhesive strength during adhesion becomes insufficient. From the above viewpoints, the 25% compressive strength is more preferably 900 kPa or less, further preferably 800 kPa or less, particularly preferably 600 kPa or less.

The lower limit of the 25% compressive strength is not particularly limited but is generally about 10 kPa, preferably 20 kPa or more.

The 25% compressive strength is a value measured at a measurement temperature of 23° C. by the measurement method according to JIS K6767.

[Thickness]

The thickness of the foam sheet of the present invention is preferably 0.03 to 2 mm. When the thickness is 0.03 mm or more, the cushioning properties or the like of the foam sheet can be easily ensured. Further, the thickness of 2 mm or less enables a reduction in thickness, and thus it can be suitably used for thin electronic devices such as smartphones and tablets. Further, the flexibility of the foam sheet is easily ensured.

From these viewpoints, the thickness of the foam sheet is more preferably 0.1 to 1.8 mm, further preferably 0.15 to 1.6 mm, furthermore preferably 0.15 to 0.7 mm.

The thickness was measured with a dial gauge.

[Storage Modulus]

The foam sheet of the present invention (first invention) preferably has a storage modulus at 23° C. of 2×10³ Pa or more. When the storage modulus is 2×10³ Pa or more, the impact resistance can be improved. From the above viewpoint, the storage modulus is more preferably 1×10⁴ Pa or more, further preferably 1×10⁵ Pa or more.

The upper limit is not particularly limited but is generally about 1×10¹² Pa, preferably 1×10¹⁰ Pa or less in view of flexibility.

The storage modulus can be measured using a tensile storage modulus measuring device, product name “DVA-200/L2”, available from IT Instrumentation & Control Co., Ltd. The measurement conditions can be the same as measurement of Tg and tanδ in Examples.

[Strength at Break]

The foam sheet of the present invention preferably has a strength at break at 23° C. of 5 N/10 mm or more. When the strength at break is 5 N/10 mm or more, good impact resistance is obtained. From the above viewpoint, the strength at break is more preferably 5.5 N/10 mm or more, further preferably 6 N/10 mm or more, further preferably 7 N/10 mm or more.

The upper limit of the strength at break is not particularly limited but is generally about 50 N/10 mm, preferably 40 N/10 mm or less.

The strength at break is a value measured by the method according to Examples.

[Elongation at Break]

The foam sheet of the present invention preferably has an elongation at break at 23° C. of 200% or more. When the elongation at break is 200% or more, good impact resistance is obtained. From the above viewpoint, the elongation at break is more preferably 300% or more, further preferably 400% or more.

The upper limit of the elongation at break is not particularly limited but is generally about 800%, preferably 600% or less.

The elongation at break is a value measured by the method according to Examples.

[Closed Cell Ratio]

The foam sheet of the present invention preferably has a closed cell ratio of 80% or more. When the closed cell ratio is 80% or more, the cushioning properties and impact resistance become good, and the original elasticity of the foam sheet is easily maintained even after heating or cooling. There is also an advantage that the rate of change in compressive strength tends to be low. Further, the waterproofness and water vapor transmission rate are also enhanced.

From the above viewpoints, the closed cell ratio of the foam sheet is further preferably 90% or more. A higher closed cell ratio is better, and it may be 100% or less.

The closed cell ratio was measured by the method according to Examples.

[Average Cell Size]

The foam sheet of the present invention preferably has an average cell size of 20 to 400 μm. When the average cell size falls within such a range, the impact resistance is good. From the above viewpoint, the average cell size is more preferably 50 to 350 μm, further preferably 70 to 300 μm, furthermore preferably 70 to 220 μm

The average cell size in the present invention is a larger value of the average of the cell sizes in the machine direction (MD) and the average of the cell sizes in a direction perpendicular to MD (TD: Transverse Direction).

Further, the average cell size was measured by the method according to Examples.

[Crosslinking Degree (Gel Fraction)]

The foam sheet of the present invention is preferably crosslinked, and the crosslinking degree represented by the gel fraction is preferably 30 to 80 mass %. When the crosslinking degree falls within such a range, the impact resistance is easily enhanced in the foam sheet, while a certain flexibility and cushioning properties are ensured. From the above viewpoints, the gel fraction is more preferably 35 to 70 mass %, further preferably 38 to 65 mass %.

The gel fraction is a value measured by the method according to Examples.

[Apparent Density]

The apparent density of the foam sheet of the present invention is preferably 0.05 g/cm³ to 0.70 g/cm³, more preferably 0.06 g/cm³ to 0.65 g/cm³, further preferably 0.07 g/cm³ to 0.60 g/cm³, particularly preferably 0.10 g/cm³ to 0.45 g/cm³.

When the apparent density falls within such a range, the flexibility, cushioning properties, relative dielectric constant, and the like of the foam sheet are easily enhanced. Further, a certain mechanical strength is imparted to the foam sheet, and the impact resistance, handleability, and the like are also easily enhanced.

The apparent density is a value measured according to JIS K7222 (2005).

[Water Vapor Transmission Rate]

The foam sheet of the present invention (first invention and third invention) preferably has a water vapor transmission rate (WVTR: Water Vapor Transmission Rate) of 400 g/m²·day or less. When the water vapor transmission rate is 400 g/m²·day or less, it is possible to prevent moisture from entering the inside of an electronic device or the like. From the above viewpoint, the water vapor transmission rate is preferably 200 g/m²·day or less, further preferably 100 g/m²·day or less, particularly preferably 80 g/m²·day or less.

The lower limit is not particularly limited but is generally about 5 g/m²·day.

The water vapor transmission rate (WVTR: Water Vapor Transmission Rate) of the foam sheet of the present invention (second invention) is 400 g/m²·day or less. When the water vapor transmission rate exceeds 400 g/m²·day, water vapor may enter mobile electronic devices such as smartphones, leading to failure of electronic components. Meanwhile, when the water vapor transmission rate is 400 g/m²·day or less, it is possible to prevent moisture from entering the inside of an electronic device or the like. From the above viewpoints, the water vapor transmission rate is preferably 200 g/m²·day or less, further preferably 100 g/m²·day or less, particularly preferably 80 g/m²·day or less.

The lower limit is not particularly limited but is generally about 5 g/m²·day. The water vapor transmission rate is a value measured by the method according to Examples.

[Relative Dielectric Constant]

The foam sheet of the present invention (first invention and second invention) preferably has a relative dielectric constant of 2 or less. When the relative dielectric constant is 2 or less, no communication delay occurs, and even when used in 5G-compatible electronic devices, the problem of communication delay is less likely to occur. When the relative dielectric constant is 2 or less, operational errors are also less likely to occur in electronic devices. From the above viewpoints, the relative dielectric constant is more preferably 1 to 1.80, further preferably 1 to 1.70, particularly preferably 1 to 1.55.

The relative dielectric constant is a value measured by the method according to Examples.

Further, the relative dielectric constant can be appropriately adjusted depending on the type of the resin constituting the foam sheet, the apparent density, and the like.

The foam sheet of the present invention (third invention) has a relative dielectric constant of 2 or less. When the relative dielectric constant exceeds 2, communication delay may occur, and particularly when used in 5G-compatible electronic devices, the problem of communication delay tends to occur. When the relative dielectric constant exceeds 2, operational errors may be caused in electronic devices. From the above viewpoints, the relative dielectric constant is preferably 1 to 1.80, more preferably 1 to 1.70, further preferably 1 to 1.55.

The relative dielectric constant is a value measured by the method according to Examples.

Further, the relative dielectric constant can be appropriately adjusted depending on the type of the resin constituting the foam sheet, the apparent density, and the like.

[Constituent Resin]

The resin constituting the foam sheet of the present invention preferably contains a polyolefin resin. It is possible to impart a strength to the foam sheet by containing a polyolefin resin. Further, the constituent resin preferably contains an elastomer, and the constituent resin preferably contains (A) an elastomer and (B) a polyolefin resin. Use of an elastomer and a polyolefin resin can enhance the flexibility, impact resistance, relative dielectric constant, and the like, while enhancing the foamability and the like.

The elastomer resin (A) according to the present invention preferably has a maximum peak temperature of tanδby dynamic viscoelasticity measurement of 0 to 40° C. When the maximum peak temperature of tanδis near normal temperature in this way, the sound absorbing characteristics are improved, and the vibration resistance is easily improved. From the above viewpoints, the maximum peak temperature of tanδof the elastomer resin is more preferably 5 to 35° C., further preferably 10 to 30° C.

As used herein, the term “maximum peak temperature of tano” refers to a value measured by a dynamic viscoelasticity measuring device in a tension mode at a heating rate of 10° C./minute and a frequency of 10 Hz. As a dynamic viscoelasticity measuring device that can be used for measurement, “RHEOVIBRON DDV-III”, available from ORIENTEC CO., LTD. can be mentioned.

Meanwhile, the polyolefin resin (B) exhibits a Tg at low temperature 31 40° C. or less) and ensures flexibility as a foam sheet even in cold areas at about −-20° C.

[Mass ratio of elastomer resin (A) to polyolefin resin (B)]

The mass ratio of the elastomer resin (A) to the polyolefin resin (B) is preferably 90:10 to 15:85. Within such a range, the flexibility, impact resistance, and low temperature characteristics can be enhanced, while the sound absorbing characteristics are improved, and the vibration resistance is likely to be improved, as described above, and the foamability and the like are enhanced. Further, within such a range, a foam sheet exerting the effects of the present invention can be easily produced.

From the above viewpoints, the mass ratio of (A) component to (B) component is more preferably in the range of 80:20 to 20:80, further preferably 80:20 to 30:70.

(Elastomer (A))

Examples of the elastomer (A) include thermoplastic elastomers, ethylene-Ε-olefin copolymer rubbers, and amorphous 4-methyl-1 pentene copolymers. Examples of the thermoplastic elastomers include thermoplastic olefin elastomers, thermoplastic styrene elastomers, thermoplastic vinyl chloride elastomers, thermoplastic polyurethane elastomers, thermoplastic polyester elastomer, and thermoplastic polyamide elastomers. The elastomer (A) may use these components individually by one type or may use two or more of them in combination.

Among these, thermoplastic olefin elastomers, thermoplastic styrene elastomers, and ethylene-α-olefin copolymer rubbers are preferable, thermoplastic styrene elastomers, ethylene-α-olefin copolymer rubbers are more preferable, and thermoplastic styrene elastomers are further preferable.

<Thermoplastic Olefin Elastomer>

A thermoplastic olefin elastomer (TPO) generally has a polyolefin such as polyethylene and polypropylene as a hard segment and has a rubber component such as butyl rubber, halobutyl rubber, EPDM (ethylene-propylene-diene rubber), EPM (ethylene-propylene rubber), NBR (acrylonitrile-butadiene rubber), and natural rubber as a soft segment. As the thermoplastic olefin elastomer (TPO), any of blend type, dynamic crosslinking type, and polymerization type can be used.

Preferred specific examples of the rubber component include EPM and EPDM, as mentioned above, and EPDM is particularly preferable. Examples of EPDM include ethylene-propylene-5-ethylidene-2-norbornene copolymer rubber and ethylene-propylene-dicyclopentadiene copolymer rubber. Among these, ethylene-propylene-dicyclopentadiene copolymer rubber is preferable.

Further, a block copolymer type is also mentioned as a thermoplastic olefin elastomer. Examples of the block copolymer type include those having a crystalline block and a soft segment block, more specifically, crystalline olefin block-ethylene/butylene copolymer-crystalline olefin block copolymer (CEBC). In CEBC, the crystalline olefin block is preferably a crystalline ethylene block, and examples of a commercially available product of CEBC include “DYNARON 6200P”, available from JSR Corporation.

<Thermoplastic Styrene Elastomer>

Examples of the thermoplastic styrene elastomer include a block copolymer having a styrene polymer or copolymer block and a conjugated diene compound polymer or copolymer block. Examples of the conjugated diene compound include isoprene and butadiene.

The thermoplastic styrene elastomer used in the present invention may or may not be hydrogenated but is preferably hydrogenated. When it is hydrogenated, hydrogenation can be performed by a well-known method.

Thermoplastic styrene elastomers are generally block copolymers such as styrene-isoprene block copolymer (SI), styrene-isoprene-styrene block copolymer (SIS), styrene-butadiene block copolymer (SB), styrene-butadiene-styrene block copolymer (SBS), styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-ethylene/butylene block copolymer (SEB), styrene-ethylene/propylene block copolymer (SEP), and styrene-ethylene/butylene-crystalline olefin block copolymer (SEBC).

As the thermoplastic styrene elastomers, block copolymers are preferable. Among them, SIS, SEBS, SEPS, SEEPS, and SEBC are more preferable, SEEPS and SEBS are further preferable, and SEBS is particularly preferable.

Examples of a commercially available product of SEBS include Tuftec (R) Series and S.O.E.(R) Series, available from Asahi Kasei Corporation.

The thermoplastic styrene elastomers can enhance the impact resistance of the foam sheet by having styrene-derived structural units. The styrene content in a thermoplastic styrene elastomer is preferably 5 to 50 mass %. When the styrene content falls within such a range, excellent impact resistance is obtained. Further, when it is the aforementioned upper limit or less, the compatibility with the polyolefin resin (B), which will be described later in detail, becomes good, and the crosslinkability and foamability tend to be good. From these viewpoints, the styrene content in a thermoplastic styrene elastomer is more preferably 7 to 40 mass %, further preferably 7 to 30 mass %.

The number-average molecular weight of the thermoplastic styrene elastomer is not specifically limited but is preferably 30,000 to 800,000, more preferably 120,000 to 180,000, in view of the strength at break and processability.

The number-average molecular weight is a value converted into polystyrene measured using gel permeation chromatography (GPC).

<Ethylene-α-Olefin Copolymer Rubber>

Examples of the α-olefin used for the ethylene-α-olefin copolymer rubber include one or more α-olefins having 3 to 15 carbon atoms, preferably having 3 to 10 carbon atoms, such as propylene, 1-butene, 2-methyl propylene, 3-methyl-1-butene, 1-pentene, 1-hexene, 4-methyl-1-pentene, and 1-octene. Among these, propylene and 1-butene are preferable, and 1-butene is more preferable.

The ethylene-α-olefin copolymer rubber used here is an amorphous or low crystalline rubber-like substance in which two or more olefin monomers are copolymerized substantially at random.

The ethylene-α-olefin copolymer rubber may have other monomer units in addition to ethylene units and α-olefin units.

Examples of monomers forming the other monomer units include conjugated dienes having 4 to 8 carbon atoms such as 1,3-butadiene, 2-methyl-1,3-butadiene (isoprene), 1,3-pentadiene, and 2,3-dimethyl-1,3-butadiene, non-conjugated dienes having 5 to 15 carbon atoms such as dicyclopentadiene, 5-ethylidene-2-norbornene, 1,4-hexadiene, 1, 5-dicyclooctadiene, 7-methyl-1,6-octadiene, and 5-vinyl-2-norbornene, vinyl ester compounds such as vinyl acetate, unsaturated carboxylic acid esters such as methyl acrylate, ethyl acrylate, butyl acrylate, methyl methacrylate, and ethyl methacrylate, and unsaturated carboxylic acids such as acrylic acid and methacrylic acid. These monomers can be used alone, or two or more of them can be used in combination. Among these, non-conjugated dienes having 5 to 15 carbon atoms are preferable, and 5-ethylidene-2-norbornene, 1,4-hexadiene, and dicyclopentadiene (DCPD) are more preferable in view of availability.

The content of ethylene units in the ethylene-α-olefin copolymer rubber is generally 30 to 85 mass %, preferably 40 to 80 mass %, more preferably 45 to 75 mass %. Further, the content of α-olefin units having 3 to 15, preferably, 3 to 10 carbon atoms such as propylene is generally 10 to 60 mass %, preferably 15 to 50 mass. The content of the other monomer units such as non-conjugated dienes is generally 0 to 20 mass %, preferably 1 to 10 mass %.

As the ethylene-α-olefin copolymer rubber, ternary copolymers such as EPDM (ethylene-propylene-diene rubber) and EBDM (ethylene-butene-1-diene rubber) are preferable. Examples of the ethylene-α-olefin copolymer include “EBT K-9330”, available from Mitsui Chemicals, Inc.

<Amorphous 4-Methyl-1 Pentene Copolymer>

Examples of the amorphous 4-methyl-1 pentene copolymer include copolymers of 4-methyl-1 pentene with α-olefins other than 4-methyl-1 pentene. Examples of the α-olefins include α-olefins having 2 to 20 carbon atoms, preferably ethylene, propylene, 1-butene, 1-pentene, 1-hexene, 1-octene, or 1-decene, more preferably ethylene or propylene. Among them, 4-methyl-1 pentene/propylene copolymer is preferable.

Examples of the amorphous 4-methyl-1 pentene copolymer include “EP1001”, available from Mitsui Chemicals, Inc.

(Polyolefin Resin (B))

The polyolefin resin is a thermoplastic resin, and specific examples thereof include polyethylene resins, polypropylene resins, polybutene resins, and ethylene-vinyl acetate copolymers. Among these, polyethylene resins are preferable. Use of a polyethylene resin makes it easy to lower the relative dielectric constant. Further, it makes it easier to lower the water vapor transmission rate.

Further, as a polyethylene resin, low density polyethylene (LDPE) is preferable, and linear low density polyethylene (LLDPE) is furthermore preferable. Accordingly, use of a thermoplastic styrene elastomer as the elastomer (A) and use of LLDPE as the polyolefin resin (B) is particularly preferable.

Further, examples of the polyethylene resin include polyethylene resins polymerized with polymerization catalysts such as Ziegler-Natta catalysts, metallocene catalysts, and chromium oxide compounds, and polyethylene resins polymerized with metallocene catalysts are preferably used.

(Metallocene Catalyst)

Examples of the metallocene catalysts can include compounds such as bis(cyclopentadienyl) metal complexes having a structure in which a transition metal is sandwiched between π electron unsaturated compounds. More specifically, examples thereof can include compounds in which one or more cyclopentadienyl rings or analogs thereof are present as ligands in tetravalent transition metals such as titanium, zirconium, nickel, palladium, hafnium, and platinum.

Such metallocene catalysts have uniform properties of active sites and each active site has the same activity. Since polymers synthesized using metallocene catalysts have high uniformities in molecular weight, molecular weight distribution, composition, composition distribution, and the like, crosslinking uniformly proceeds when sheets containing polymers synthesized using metallocene catalysts are crosslinked. Since the uniformly crosslinked sheets uniformly foam, it is easy to stabilize the physical properties. Further, since they can be uniformly stretched, the thickness of foams can be uniform.

Examples of ligands can include cyclopentadienyl rings and indenyl rings. Such a cyclic compound is optionally substituted with a hydrocarbon group, a substituted hydrocarbon group, or a hydrocarbon-substituted metalloid group. Examples of the hydrocarbon group include a methyl group, an ethyl group, various propyl groups, various butyl groups, various amyl groups, various hexyl groups, 2-ethylhexyl group, various heptyl groups, various octyl groups, various nonyl groups, various decyl groups, various cetyl groups, and a phenyl group. The term “various” means various isomers including n-, sec-, tert-, and iso-.

Further, a cyclic compound polymerized as an oligomer may be used as a ligand.

Further, monovalent anion ligands such as chlorine and bromine, divalent anion chelate ligands, hydrocarbons, alkoxides, arylamides, aryloxides, amides, phosphides, arylphosphides, or the like may be used other than TC electron unsaturated compounds.

Examples of metallocene catalysts containing tetravalent transition metals and ligands include cyclopentadienyltitanium tris(dimethylamide), methylcyclopentadienyltitanium tris(dimethylamide), bis(cyclopentadienyl)titanium dichloride, and dimethylsilyltetramethylcyclopentadienyl-t-butylamidozirconium dichloride.

A metallocene catalyst combined with a specific co-catalyst (promoter) exert its action as a catalyst when polymerizing various olefins. Specific examples of the co-catalyst include methylaluminoxane (MAO) and boron compounds. The ratio of the co-catalyst to be used with respect to the metallocene catalyst is preferably 10 to 1,000,000 mol times, more preferably 50 to 5,000 mol times.

Further, the polyethylene resin is preferably linear low density polyethylene. The linear low density polyethylene is more preferably linear low density polyethylene obtained by copolymerizing ethylene (for example, 75 mass % or more, preferably 90 mass % or more with respect to the total monomer amount) and a small amount of α-olefin, as required. Specifically, examples of the α-olefin include propylene, 1-butene, 1-pentene, 4-methyl-1-pentene, 1-hexene, 1-heptene, and 1-octene. Among these, α-olefins having 4 to 10 carbon atoms are preferable.

The density of the polyethylene resin, for example, the aforementioned linear low density polyethylene is preferably 0.870 to 0.925 g/cm³, more preferably 0.890 to 0.925 g/cm³, further preferably 0.910 to 0.925 g/cm³, in view of flexibility. A plurality of polyethylene resins can be used as the polyethylene resin, and a polyethylene resin having a density other than the aforementioned range may be added.

Examples of ethylene-vinyl acetate copolymers used as polyolefin resins include ethylene-vinyl acetate copolymers containing 50 mass % or more of ethylene.

Further, examples of polypropylene resins include homopolypropylene and propylene-α-olefin copolymers containing 50 mass % or more of propylene. These may be used individually by one type, or two or more of them may be used in combination. Specifically, examples of α-olefins constituting the propylene-α-olefin copolymer can include ethylene, 1-butene, 1-pentene, 4-methyl-1-pentene, 1-hexene, 1-heptene, and 1-octene. Among these, α-olefins having 6 to 12 carbon atoms are preferable.

Examples of the polybutene resins can include homopolymers of butene-1 and copolymers with ethylene or propylene.

[Additive]

The foam sheet of the present invention is preferably obtained by foaming the aforementioned resin and a foamable composition containing a foaming agent. The foaming agent is preferably a thermally decomposable foaming agent.

As the thermally decomposable foaming agent, organic foaming agents and inorganic foaming agents can be used. Examples of the organic foaming agents include azo compounds such as azodicarbonamide, azodicarbon acid metal salt (such as barium azodicarboxylate), and azobisisobutyronitrile, nitroso compounds such as N,N′-dinitrosopentamethylenetetramine, hydrazine derivatives such as hydrazodicarbonamide, 4,4′-oxybis (b enzenesulfonylhydrazide), and toluenesulfonylhydrazide, and semicarbazide compounds such as toluenesulfonylsemicarbazide.

Examples of the inorganic foaming agents include ammonium carbonate, sodium carbonate, ammonium bicarbonate, sodium bicarbonate, ammonium nitrite, sodium borohydride, and anhydrous monosodium citrate.

Among these, azo compounds are preferable, and azodicarbonamide is more preferable, in view of economic efficiency and safety, for obtaining fine cells.

The thermally decomposable foaming agents may be used individually by one type, or two or more of them may be used in combination.

The amount of the foaming agent to be mixed in the foamable composition is preferably 1 part by mass or more and 20 parts by mass or less, more preferably 1.5 parts by mass or more and 15 parts by mass or less, further preferably 3 parts by mass or more and 10 parts by mass or less, with respect to 100 parts by mass of the resin. When the amount of the foaming agent to be mixed is 1 part by mass or more, the foamable sheet is appropriately foamed, and appropriate flexibility and appropriate impact absorption can be imparted to the foam sheet. Further, when the amount of the foaming agent to be mixed is 20 parts by mass or less, the foam sheet is prevented from foaming more than necessary, and the mechanical strength of the foam sheet and the like can be enhanced.

The foamable composition may contain a decomposition temperature adjuster. The decomposition temperature adjuster is contained to have an adjusting function such as lowering the decomposition temperature of the thermally decomposable foaming agent and accelerating the degradation rate, and specific compounds include zinc oxide, zinc stearate, and urea. The decomposition temperature adjuster is contained, for example, in an amount of 0.01 to 5 parts by mass with respect to 100 parts by mass of the resin, for adjusting the surface conditions of the foam sheet.

The foamable composition may contain an antioxidant. Examples of the antioxidant include phenolic antioxidants such as 2,6-di-t-butyl-p-cresol, sulfur antioxidants, phosphorus antioxidants, and amine antioxidants. The antioxidant is contained, for example, in an amount of 0.01 to 5 parts by mass with respect to 100 parts by mass of the resin.

The foamable composition may contain commonly used additives for foams such as heat stabilizers, colorants, flame retardants, antistatic agents, fillers other than these examples.

The foam sheet mainly contains the elastomer (A) and the polyolefin resin (B), and the total content of the component (A) and the component (B) is, for example, 70 mass % or more, preferably 80 mass % or more, more preferably 90 mass % or more, based on the total amount of the foam sheet.

[Method for Producing Foam Sheet]

The foam sheet of the present invention is not particularly limited but can be produced by heating a foamable sheet composed of a foamable composition containing at least a resin and a thermally decomposable foaming agent and foaming the thermally decomposable foaming agent. Further, the foamable sheet is preferably crosslinked, and the crosslinked foamable sheet is heated to be foamed.

More specifically, the method for producing a foam sheet preferably includes steps (1) to (3) below.

Step (1): a step of forming a foamable sheet consisting of a foamable composition containing at least a resin and a thermally decomposable foaming agent;
Step (2): a step of crosslinking the foamable sheet by irradiating the foamable sheet with ionizing radiation; and
Step (3): a step of obtaining a foam sheet by heating the crosslinked foamable sheet and foaming the thermally decomposable foaming agent.

In step (1), the method for forming a foamable sheet is not specifically limited, but a resin and an additive may be supplied to an extruder and melt-kneaded, so that a foamable composition is extruded from the extruder into a sheet, for example. Further, the foamable sheet may be formed by pressing the foamable composition. The forming temperature of the foamable sheet (that is, the temperature at the time of extrusion or the temperature at the time of pressing) is preferably 50° C. or more and 250° C. or less, more preferably 80° C. or more and 180° C. or less.

As the method for crosslinking the foamable composition in step (2), a method of irradiating the foamable sheet with ionizing radiation such as electron beams, a rays, 13 rays, and 7 rays is used. The irradiation dose of the ionizing radiation may be adjusted so that the crosslinking degree of the foam sheet to be obtained is within the aforementioned desired range but is preferably 1 to 12 Mrad, more preferably 1.5 to 10 Mrad.

In step (3), the heating temperature at which the foamable composition is heated to foam the thermally decomposable foaming agent may be the foaming temperature of the thermally decomposable foaming agent or more but is preferably 200 to 300° C., more preferably 220 to 280° C. In step (3), the foamable composition is foamed so that cells are formed to form a foam.

Further, in this production method, the foam sheet may be thinned by a method such as rolling and stretching.

However, this production method is not limited to the above, and a foam sheet may be obtained by a method other than the above. For example, crosslinking may be performed by mixing an organic peroxide in the foamable composition in advance and heating the foamable sheet to decompose the organic peroxide, instead of irradiation with ionizing radiation.

Further, if crosslinking is not necessary, step (2) may be omitted. In such a case, an uncrosslinked foamable sheet may be heated to be foamed in step (3).

[Pressure-Sensitive Adhesive Tape]

The foam sheet of the present invention may use a pressure-sensitive adhesive tape using a foam sheet as a base material. The pressure-sensitive adhesive tape, for example, includes a foam sheet and a pressure-sensitive adhesive material provided on at least any one surface of the foam sheet. The pressure-sensitive adhesive tape can adhere to another member such as a support member via the pressure-sensitive adhesive material. The pressure-sensitive adhesive tape may be foam sheet provided with the pressure-sensitive adhesive material on each of both sides or may be provided with the pressure-sensitive adhesive material on one side.

Further, the pressure-sensitive adhesive material may include at least a pressure-sensitive adhesive layer and may be a pressure-sensitive adhesive layer alone laminated on the surface of the foam sheet or a double-sided pressure-sensitive adhesive sheet attached to the surface of the foam sheet. However, it is preferably a pressure-sensitive adhesive layer alone. The double-sided pressure-sensitive adhesive sheet includes a base material and a pressure-sensitive adhesive layer provided on each of both sides of a base material. The double-sided pressure-sensitive adhesive sheet is used for attaching one pressure-sensitive adhesive layer to the foam sheet and attaching the other pressure-sensitive adhesive layer to another member.

The pressure-sensitive adhesive constituting the pressure-sensitive adhesive layer is not particularly limited and acrylic pressure-sensitive adhesives, urethane pressure-sensitive adhesives, rubber pressure-sensitive adhesives, silicone pressure-sensitive adhesives, and the like can be used, for example. A release sheet such as a mold release paper may be bonded further on the pressure-sensitive adhesive material.

The thickness of the pressure-sensitive adhesive layer is preferably 5 to 200 μm, more preferably 7 to 150 μm, further preferably 10 to 100 μm.

[Foam Sheet Roll]

The foam sheet of the present invention can be made into a roll. The roll makes it easy to store and is convenient for transportation. When used, it can be unwound from the roll for use.

[Applications of Foam Sheet]

The applications of the foam sheet are not specifically limited, but the foam sheet is preferably used as a cushioning material for display devices. Specifically, it may be disposed on the back side of a display panel provided in various electronic devices used to absorb the impact acting on the display panel. In this case, the foam sheet may be disposed on a support member disposed on the back side of the display panel. The support member constitutes, for example, a part of the housing of various electronic devices.

Further, it is preferably used as a cushioning material between the battery and the back cover material of mobile electronic devices such as smartphones. Vibration generated in the back cover material can be effectively suppressed.

The foam sheet may be provided with a pressure-sensitive adhesive material, as described above, and may be bonded with a display panel, a support member, a back cover material, or the like with the pressure-sensitive adhesive material.

Having a tanδ peak around normal temperature, the foam sheet of the present invention can exert a vibration resistance action and is particularly effective for electronic devices such as smartphones whose back cover material is made of glass or the like. Electronic devices have built-in acoustic members such as speakers, and the back cover material made of glass or the like is easily vibrated by the acoustic members. However, the foam sheet of the present invention can effectively prevent the vibration by having an excellent vibration resistance effect in a low frequency band.

Further, since the foam sheet of the present invention does not lose its flexibility even at low temperature, no cracking occur even in cold areas of about −20° C., for example.

Further, since the foam sheet of the present invention has excellent moisture permeation resistance, it is useful as a cushioning material for mobile electronic devices such as smartphones as a material that satisfies all of cushioning properties, vibration resistance, and moisture permeation resistance.

Further, since the foam sheet of the present invention has a low relative dielectric constant, it does not cause communication delay when used for mobile electronic devices such as smartphones. In particular, when used in high-speed communication equipment such as the fifth generation mobile communication system (5G), the effect is exhibited even more.

### EXAMPLES

Hereinafter, the present invention will be described by way of examples, but the present invention is not limited to these examples at all.

The method for measuring physical properties and the method for evaluating the foam sheet are as follows.

[Physical Properties After Forming]

(1) Glass transition temperature (Tg) and loss tangent (tanδ)

Tg and tanδ were determined under the following measurement conditions using a tensile storage modulus measuring device, product name “DVA-200/L2”, available from IT Instrumentation & Control Co., Ltd.

### (Measurement Conditions)

Gauge length: 2.5 cm

Sample width: 0.5 cm

Sample thickness: Thickness of the foam sheet

Deformation mode: Tensile

Static/dynamic stress ratio: 1.5

Set distortion: 1.0%

Set heating rate: 10° C./min

Measurement frequency: 10 Hz

Temperature range: −150° C. to 100° C.

(2) Strength at Break and Elongation at Break

The foam sheet produced in each of Examples and Comparative Examples was cut into a dumbbell-shaped No. 1 shape defined in JIS K6251 4.1. This was used as a sample, and the sample was stretched in the MD direction at a measurement temperature of 23° C. and a rate of 500 mm/min using a tensile tester (product name: TENSILON RTF235, available from A&D Company, Limited), to measure the tensile strength (strength at break, unit: N/10 mm) and the tensile elongation (elongation at break, unit: %) at break.

(3) Crosslinking Degree (Gel Fraction)

About 100 mg of a test piece was collected from the foam sheet, and the mass A (mg) of the test piece was accurately weighed. Then, the test piece was immersed in 30 cm3 of xylene at 120° C., allowed to stand for 24 hours, and then filtered with a 200 mesh wire screen to collect the insoluble residue on the wire screen, followed by vacuum drying, and the mass B (mg) of the insoluble residue was accurately weighed. From the resulting value, the crosslinking degree (mass %) was calculated by the following formula.

Gel fraction (mass %)=100×(B/A)

(4) Closed cell ratio

From the foam sheet, a flat square test piece with a side of 5 cm was cut out. The thickness of the test piece was measured to calculate the appearance volume V1 of the test piece, and the mass W1 of the test piece is measured.

Then, the volume V2 occupied by the cells was calculated based on the following formula. The density of the test piece was referred to as ρ(g/cm³).

Volume V2 occupied by cells=V1−W1/ρ

Subsequently, the test piece was submerged into distilled water at 23° C. to a depth of 100 mm from the water surface, to apply a pressure of 15 kPa to the test piece for 3 minutes. Thereafter, the test piece was taken out of water, and water adhering to the surface of the test piece was removed, the mass W2 of the test piece was measured, and the closed cell ratio F1 was calculated based on the following formula.

Closed cell ratio F1 (%)=100−100×(W2−W1)/V2

(5) Average Cell Size

The foam sheet was cut in the thickness direction along each of MD and TD, to capture a 200-fold enlarged image using a digital microscope (product name: “VHX-900”, available from KEYENCE CORPORATION). In the captured enlarged image, the cell sizes in each of the MD and TD were measured for all cells present on a 2 mm long cut surface, and the operation was repeated 5 times. Then, the average of the cell sizes in the MD and TD of all cells was taken as the average cell size in the MD and TD.

MD indicates the machine direction, which is the same direction as the extrusion direction. TD indicates the transverse direction, which is a direction orthogonal to MD and parallel to the foam sheet.

(6) 25% compressive strength

It was measured by the measurement method according to JIS K6767 at a measurement temperature of 23° C.

(7) Apparent density and expansion ratio

For the foam, the apparent density was measured according to JIS K7222, and the inverse thereof was taken as an expansion ratio.

(8) Thickness

It was measured with a dial gauge.

(9) WVTR

The foam sheet produced in each of Examples and Comparative Examples was cut out into about 10 cm×10 cm at a temperature of 40° C., and it was set in the measuring unit of a water vapor permeability measuring device (PERMATRAN-W 1/50, available from MOCON, Inc.) and thereafter measured for water vapor permeability under conditions of 40° C. and 90% RH.

The evaluation criteria were as follows.

Good: Water vapor transmission rate (WVTR) of 400 g/m²·day or less

Poor: Water vapor transmission rate (WVTR) of over 400 g/m²·day

### (10) Relative Dielectric Constant

The relative dielectric constant at a frequency of 1 MHz was determined using an LCR (impedance) analyzer “PSM3750”, available from IWATSU ELECTRIC CO., LTD. in the air at room temperature at 33 points dividing the frequency from 100 mHz to 10 MHz on a log scale, measuring one cycle, and scanning the waveform obtained.

[Evaluation]

(11) Vibration resistance evaluation (frequency vs loss tangent (tanδ))

Using a tensile storage modulus measuring device, product name “DVA-200/L2”, available from IT Instrumentation & Control Co., Ltd. under the following measurement conditions, a master curve was plotted, to determine the tanδat each frequency (Hz). The tanδpeak height in the low frequency range (10 to 1000 Hz) considered to be effective for vibration was evaluated. When the tanδpeak height was 0.3 or more, it was determined to be good, whereas when it was less than 0.3, it was determined to be poor. (Measurement conditions)

Gauge length: 2.5 cm

Sample width: 0.5 cm

Sample thickness: Thickness of foam sheet

Deformation mode: Tensile

Static/dynamic stress ratio: 1.5

Set distortion: 1.0%

Set heating rate: 10° C./min

Measurement frequency: Measurement was performed at 8 frequencies (0.32, 0.63, 1.25, 2.5, 5, 10, 20, and 40 Hz) every 5° C. in the following temperature range.

Temperature range: −70° C. to 25° C.

(12) Low temperature evaluation (low temperature elongation at break)

The foam sheet produced in each of Examples and Comparative Examples was cut into a dumbbell-shaped No. 1 shape defined in JIS K6251 4.1. This was used as a sample, and the sample was stretched in the MD direction at a measurement temperature of −20° C. and a rate of 500 mm/min using a tensile tester (product name: TENSILON RTF235, available from A&D Company, Limited), to measure the tensile elongation (unit: %) at break. When the tensile elongation at break is 100% or more, it was determined to be good, whereas when it was less than 100%, it was determined to be poor.

(13) Moisture Test (Water Vapor Transmission Rate)

The foam sheet produced in each of Examples and Comparative Examples was cut into 5 cm×7 cm, to form a test piece on the picture frame (thickness: the thickness shown in tables (mm), width: 1.5 mm). A water sensitivity test paper (ASTOOL water submersion management sheet) was put inside the test piece, and two pieces were fixed to an acrylic plate with scissors and an adhesive, to obtain a test piece for a moisture test. The test piece was allowed to stand in an oven at 23° C. and 70% RH for 24 hours. 24 hours later, changes in the water sensitivity test paper were checked. The evaluation criteria were as follows.

Good: No changes in the water sensitivity test paper

Poor: Changes in the water sensitivity test paper

(14) Radio Interference Evaluation

From the relative dielectric constant, the propagation delay time was determined based on the following formula. When the propagation delay time was less than 4.5 ns/m, it was determined to be good, whereas when it was 4.5 ns/m or more, it was determined to be poor.

In the following formula, ε represents the relative dielectric constant, τ represents the propagation delay time (ns/m), K represents the wavelength shortening rate, and C represents the speed of light (3×10⁸ m/s).

K=1/ε^{1/2} [Expression 1]

τ=1KC

The materials used in each of Examples and Comparative Examples are as follows.
Elastomer resin (a): S.O.E. (R) 51609, hydrogenated thermoplastic styrene elastomer (SEBS)
Elastomer resin (b): EP1001 (4-methyl-1 pentene/propylene copolymer, available from Mitsui Chemicals, Inc.)
Elastomer resin (c): KURARITY (R) LA3320 (acrylic thermoplastic elastomer, available from KURARAY CO., LTD.)
Polyolefin resin (a): KERNEL (R) KF283 (ethylene/α-olefin copolymer polymerized with a metallocene catalyst (LLDPE), available from Japan Polyethylene Corporation)
Polyolefin resin (b): PP-E-333GV (available from Prime Polymer Co., Ltd., density: 0.9 g/cm³, melt flow rate: 2.4 g/10 minute)
Thermally decomposable foaming agent: azodicarbonamide
Decomposition temperature adjuster: zinc oxide, product name “OW-212F”, available from Sakai Chemical Industry Co., Ltd.
Phenolic antioxidant: 2,6-di-t-butyl-p-cresol
Crosslinking agent A: 1,9-nonanediol dimethacrylate
Crosslinking agent B: trimethylolpropane trimethacrylate

### Example 1-1

40 parts by mass of the elastomer resin (a), 60 parts by mass of the polyolefin resin (a), 5 parts by mass of the thermally decomposable foaming agent, 1 part by mass of the decomposition temperature adjuster, and 0.5 parts by mass of the phenolic antioxidant were prepared as raw materials. These materials were melt-kneaded and then pressed, to obtain a foamable resin sheet with a thickness of 0.38 mm. Both sides of the foamable resin sheet obtained were irradiated with 5 Mrad of an electron beam at an acceleration voltage of 500 keV, to crosslink the foamable resin sheet. Then, the crosslinked foamable resin sheet was heated to 250° C. to be foamed, to obtain a foam sheet having an apparent density of 0.24 g/cm³ and a thickness of 0.60 mm. Thereafter, stretching was followed, to obtain a foam sheet having an apparent density of 0.24 g/cm³ and a thickness of 0.2 mm.

Table 1 shows the results of evaluation by the aforementioned method.

### Example 1-2

A foam sheet was obtained in the same manner as in Example 1-1, except that the amount of the thermally decomposable foaming agent was changed to 2.5 parts by mass, and the thickness of the foamable resin sheet was changed to 0.36 mm, in Example 1-1. The apparent density of the foam sheet was 0.48 g/cm³, and the thickness was 0.45 mm. Thereafter, stretching was followed, to obtain a foam sheet having an apparent density of 0.48 g/cm³ and a thickness of 0.15 mm. Table 1 shows the evaluation results.

### Example 1-3

A foam sheet was obtained in the same manner as in Example 1-1, except that the amount of the thermally decomposable foaming agent was changed to 6.5 parts by mass, the thickness of the foamable resin sheet was changed to 0.33 mm, and the dose of irradiation with the electron beam was changed to 4 Mrad, in Example 1-1. The apparent density of the foam sheet was 0.16 g/cm³, and the thickness was 0.60 mm. Thereafter, stretching was followed, to obtain a foam sheet having an apparent density of 0.16 g/cm³ and a thickness of 0.2 mm. Table 1 shows the evaluation results.

### Example 1-4

A foam sheet was obtained in the same manner as in Example 1-1, except that the amount of the thermally decomposable foaming agent was changed to 7 parts by mass, the thickness of the foamable resin sheet was changed to 0.58 mm, and the dose of irradiation with the electron beam was changed to 5.5 Mrad, in Example 1-1. The apparent density of the foam sheet was 0.10 g/cm³, and the thickness was 1.25 mm. Thereafter, stretching was followed, to obtain a foam sheet having an apparent density of 0.10 g/cm³ and a thickness of 0.5 mm. Table 1 shows the evaluation results.

### Example 1-5

A foam sheet was obtained in the same manner as in Example 1-1, except that the amount of the thermally decomposable foaming agent was changed to 9 parts by mass, the thickness of the foamable resin sheet was changed to 0.61 mm, and the dose of irradiation with the electron beam was changed to 6 Mrad, in Example 1-1. The apparent density of the foam sheet was 0.06 g/cm³, and the thickness was 1.5 mm. Table 1 shows the evaluation results.

### Example 1-6

A foam sheet having an apparent density after foaming of 0.24 g/cm³ and a thickness of 0.2 mm was obtained in the same manner as in Example 1-1, except that the amount of the elastomer resin (a) mixed was changed to 30 parts by mass, the amount of the polyolefin resin (a) mixed was changed to 70 parts by mass, and the dose of irradiation with the electron beam was changed to 4 Mrad, in Example 1-1. Table 1 shows the evaluation results.

### Example 1-7

A foam sheet having an apparent density after foaming of 0.24 g/cm³ and a thickness of 0.2 mm was obtained in the same manner as in Example 1-1, except that the amount of the elastomer resin (a) mixed was changed to 50 parts by mass, the amount of the polyolefin resin (a) mixed was changed to 50 parts by mass, and the dose of irradiation with the electron beam was changed to 4 Mrad, in Example 1-1. Table 1 shows the evaluation results.

### Example 1-8

A foam sheet having an apparent density after foaming of 0.23 g/cm³ and a thickness of 0.2 mm was obtained in the same manner as in Example 1-1, except that the amount of the elastomer resin (a) mixed was changed to 70 parts by mass, and the amount of the polyolefin resin (a) mixed was changed to 30 parts by mass, in Example 1-1. Table 1 shows the evaluation results.

### Example 1-9

A foam sheet having an apparent density after foaming of 0.25 g/cm³ and a thickness of 0.2 mm was obtained in the same manner as in Example 1-6, except that the elastomer resin (b) was used instead of the elastomer resin (a), and the dose of irradiation with the electron beam was changed to 6 Mrad, in Example 1-6. Table 1 shows the evaluation results.

### Example 1-10

A foam sheet having an apparent density after foaming of 0.25 g/cm³ and a thickness of 0.2 mm was obtained in the same manner as in Example 1-7 except that the elastomer resin (b) was used instead of the elastomer resin (a) in Example 1-7. Table 1 shows the evaluation results.

### Comparative Example 1-1

A foam sheet having an apparent density after foaming of 0.25 g/cm³ and a thickness of 0.2 mm was obtained in the same manner as in Example 1-1, except that 100 parts by mass of only the polyolefin resin (a) was used without using the elastomer resin, and the dose of irradiation with the electron beam was changed to 4 Mrad, in Example 1-1. Table 1 shows the evaluation results. Tg1 was not observed under the measurement conditions of the subject application.

### Comparative Example 1-2

A foam sheet having an apparent density after foaming of 0.25 g/cm³ and a thickness of 0.2 mm was obtained in the same manner as in Example 1-1, except that the amount of the elastomer resin (a) mixed was changed to 10 parts by mass, and the amount of the polyolefin resin (a) mixed was changed to 90 parts by mass, in Example 1-1. Table 1 shows the evaluation results.

### Comparative Example 1-3

A foam sheet having an apparent density of 0.25 g/cm³ and a thickness of 0.2 mm was obtained in the same manner as in Example 1-1 except that only the elastomer resin (a) was used without using the polyolefin resin in Example 1-1. Table 1 shows the evaluation results.

### Comparative Example 1-4

100 parts by mass of the elastomer resin (c), 5 parts by mass of the thermally decomposable foaming agent, 1 part by mass of the decomposition temperature adjuster, 0.5 parts by mass of the phenolic antioxidant, 1.8 parts by mass of the crosslinking agent A, and 1.2 parts by mass of the crosslinking agent B were prepared as raw materials. These materials were melt-kneaded and then pressed, to obtain a foam resin sheet having a thickness of 0.38 mm. Both sides of the foam resin sheet obtained were irradiated with 2.5 Mrad of an electron beam at an acceleration voltage of 800 keV, to crosslink the foamable resin sheet. Then, the crosslinked foamable resin sheet was heated to 250° C. to be foamed, to obtain a foam sheet having a density of 0.27 g/cm3 and a thickness of 0.60 mm. Thereafter, stretching was followed, to obtain a foam sheet having an apparent density of 0.27 g/cm³ and a thickness of 0.2 mm. Table 1 shows the evaluation results.

TABLE 1

| | | | Example | | | | | | | | | | Comparative Example | | | |
|---|---|---|---|---|---|---|---|---|---|---|---|---|---|---|---|---|
| | | | 1-1 | 1-2 | 1-3 | 1-4 | 1-5 | 1-6 | 1-7 | 1-8 | 1-9 | 1-10 | 1-1 | 1-2 | 1-3 | 1-4 |
| Compounding | Elastomer | (a)S1609 | 40 | 40 | 40 | 40 | 40 | 30 | 50 | 70 | | | | 10 | 100 | |
| | (A) | (b)EP100 | | | | | | | | | 30 | 50 | | | | |
| | | (c)LA3320 | | | | | | | | | | | | | | 100 |
| | Polyolefin | (a)KERNEL | 60 | 60 | 60 | 60 | 60 | 70 | 50 | 30 | 70 | 50 | 100 | 90 | | |
| | resin (B) | KF283 | | | | | | | | | | | | | | |
| Physical | Thickness (mm) | | 0.2 | 0.15 | 0.2 | 0.5 | 1.5 | 0.2 | 0.2 | 0.2 | 0.2 | 0.2 | 0.2 | 0.2 | 0.2 | 0.2 |
| properties | Apparent density (g/cm³) | | 0.24 | 0.48 | 0.16 | 0.10 | 0.06 | 0.24 | 0.24 | 0.23 | 0.25 | 0.25 | 0.25 | 0.25 | 0.25 | 0.27 |
| after | Expansion ratio (times) | | 4 | 2 | 6 | 10 | 15 | 4 | 4 | 4 | 4 | 4 | 4 | 4 | 4 | 4 |
| forming | Average cell size (μm) | | 121 | 89 | 142 | 165 | 251 | 79 | 81 | 78 | 72 | 89 | 95 | 92 | 92 | 88 |
| | Tg1 (Tg at 0 to 40° C.) | | 15.0 | 15.0 | 15.0 | 15.0 | 15.0 | 14.0 | 16.0 | 18.0 | 24.1 | 26.1 | — | 11.9 | 21.1 | −28.0 |
| | Tg2 (Tg at −40° C. | | −119 | −119 | −119 | −119 | −119 | −119 | −119 | −119 | −119 | −119 | −119 | −119 | — | — |
| | or less) | | | | | | | | | | | | | | | |
| | Tanδ peak value | | 0.49 | 0.49 | 0.49 | 0.49 | 0.49 | 0.38 | 0.61 | 0.82 | 0.81 | 1.29 | — | 0.13 | 1.10 | 1.30 |
| | (with Tg at 0 to 40° C.) | | | | | | | | | | | | | | | |
| | 25% compressive | | 141 | 561 | 75 | 63 | 59 | 133 | 124 | 128 | 113 | 117 | 124 | 119 | 134 | 131 |
| | strength (kPa) | | | | | | | | | | | | | | | |
| | Strength at break | | 8.7 | 13.1 | 5.8 | 8.7 | 17.4 | 9.9 | 7.8 | 6.5 | 14.9 | 14.9 | 14.9 | 13.1 | 6.7 | 2.0 |
| | (N/10 mm) at 23° C. | | | | | | | | | | | | | | | |
| | Elongation at break | | 451 | 471 | 431 | 441 | 461 | 431 | 451 | 461 | 501 | 486 | 461 | 441 | 499 | 521 |
| | (%) at 23° C. | | | | | | | | | | | | | | | |
| | WVTR(g/m2 · day) | | 54.0 | 36.0 | 81.1 | 54.0 | 27.0 | 47.3 | 60.9 | 74.2 | 45.4 | 57.2 | 27.8 | 33.7 | 86.7 | 521.0 |
| | Closed cell ratio (%) | | 99% | 98% | 100% | 99% | 99% | 97% | 100% | 98% | 99% | 98% | 99% | 98% | 98% | 98% |
| | Crosslinking degree | | 51% | 53% | 42% | 54% | 51% | 43% | 40% | 53% | 62% | 40% | 33% | 45% | 45% | 46% |
| | (gel fraction) | | | | | | | | | | | | | | | |
| Evaluation | Vibration | Frequency at | 232 | 232 | 232 | 232 | 232 | 386 | 140 | 51 | 61 | 50 | — | 1067 | 11 | 12500000 |
| | evaluation | tanδ peak | | | | | | | | | | | | | | |
| | | Deter- | Good | Good | Good | Good | Good | Good | Good | Good | Good | Good | Poor | Poor | Good | Poor |
| | | mination | | | | | | | | | | | | | | |
| | Low | Elongation at | 183 | 183 | 183 | 183 | 183 | 205 | 159 | 104 | 243 | 251 | 257 | 242 | 3 | 98 |
| | temperature | break (%) at | | | | | | | | | | | | | | |
| | evaluation | −20° C. | | | | | | | | | | | | | | |
| | | Deter- | Good | Good | Good | Good | Good | Good | Good | Good | Good | Good | Good | Good | Poor | Poor |
| | | mination | | | | | | | | | | | | | | |

As described above, all of the foam sheets of Examples showed good results in the vibration resistance evaluation and can suppress vibration on the back side, for example, when used in mobile electronic devices such as smartphones. This effect is more exerted particularly when a material such as glass and polycarbonate is used as a backing material.

Meanwhile, the foam sheets of Comparative Examples do not have a tanδpeak around normal temperature in the vibration resistance evaluation or have a small tanδ peak value, and thus it can be seen that a vibration resistance effect is not obtained.

Further, the foam sheet of the present invention (first invention) has good elongation at break at low temperature, and it is clear that a flexibility is ensured even in cold areas, for example, at about −20° C., and no cracking occurs.

Meanwhile, the foam sheet of Comparative Example 1-3 consisting of only an elastomer and the foam sheet of Comparative Example 1-4 consisting of an acrylic thermoplastic elastomer had a small elongation at break at −20° C., and it can be seen that use in cold areas is difficult.

### Example 2-1

40 parts by mass of the elastomer resin (a), 60 parts by mass of the polyolefin resin (a), 5 parts by mass of the thermally decomposable foaming agent, 1 part by mass of the decomposition temperature adjuster, and 0.5 parts by mass of the phenolic antioxidant were prepared as raw materials. These materials were melt-kneaded and then pressed, to obtain a foamable resin sheet having a thickness of 0.38 mm. Both sides of the foamable resin sheet obtained were irradiated with 5 Mrad of an electron beam at an acceleration voltage of 500 keV, to crosslink the foamable resin sheet. Then, the crosslinked foamable resin sheet was heated to 250° C. to be foamed, to obtain a foam sheet having an apparent density of 0.24 g/cm³ and a thickness of 0.60 mm. Thereafter, stretching was followed, to obtain a foam sheet having an apparent density of 0.24 g/cm³ and a thickness of 0.2 mm.

Table 2 shows the results of evaluation by the aforementioned method.

### Example 2-2

A foam sheet was obtained in the same manner as in Example 2-1, except that the amount of the thermally decomposable foaming agent was changed to 2.5 parts by mass, and the thickness of the foamable resin sheet was changed to 0.36 mm, in Example 2-1. The apparent density of the foam sheet was 0.48 g/cm³, and the thickness was 0.45 mm. Thereafter, stretching was followed, to obtain a foam sheet having an apparent density of 0.48 g/cm³ and a thickness of 0.15 mm. Table 2 shows the evaluation results.

### Example 2-3

A foam sheet was obtained in the same manner as in Example 2-1, except that the amount of the thermally decomposable foaming agent was changed to 6.5 parts by mass, the thickness of the foamable resin sheet was changed to 0.33 mm, and the dose of irradiation with the electron beam was changed to 4 Mrad, in Example 2-1. The apparent density of the foam sheet was 0.16 g/cm³, and the thickness was 0.60 mm. Thereafter, stretching was followed, to obtain a foam sheet having an apparent density of 0.16 g/cm³ and a thickness of 0.2 mm. Table 2 shows the evaluation results.

### Example 2-4

A foam sheet was obtained in the same manner as in Example 2-1, except that the amount of the thermally decomposable foaming agent was changed to 7 parts by mass, the thickness of the foamable resin sheet was changed to 0.58 mm, and the dose of irradiation with the electron beam was changed to 5.5 Mrad, in

Example 2-1. The apparent density of the foam sheet was 0.10 g/cm³, and the thickness was 1.25 mm. Thereafter, stretching was followed, to obtain a foam sheet having an apparent density of 0.10 g/cm³ and a thickness of 0.5 mm. Table 2 shows the evaluation results.

### Example 2-5

A foam sheet was obtained in the same manner as in Example 2-1, except that the amount of the thermally decomposable foaming agent was changed to 9 parts by mass, the thickness of the foamable resin sheet was changed to 0.61 mm, and the dose of irradiation with the electron beam was changed to 6 Mrad, in Example 2-1. The apparent density of the foam sheet was 0.06 g/cm³, and the thickness was 1.5 mm. Table 2 shows the evaluation results.

### Example 2-6

A foam sheet having an apparent density after foaming of 0.24 g/cm³ and a thickness of 0.2 mm was obtained in the same manner as in Example 2-1, except that the amount of the elastomer resin (a) mixed was changed to 30 parts by mass, the amount of the polyolefin resin (a) mixed was changed to 70 parts by mass, and the dose of irradiation with the electron beam was changed to 4 Mrad, in Example 2-1. Table 2 shows the evaluation results.

### Example 2-7

A foam sheet having an apparent density after foaming of 0.24 g/cm³ and a thickness of 0.2 mm was obtained in the same manner as in Example 2-1, except that the amount of the elastomer resin (a) mixed was changed to 50 parts by mass, the amount of the polyolefin resin (a) mixed was changed to 50 parts by mass, and the dose of irradiation with the electron beam was changed to 4 Mrad, in Example 2-1. Table 2 shows the evaluation results.

### Example 2-8

A foam sheet having an apparent density after foaming of 0.23 g/cm³ and a thickness of 0.2 mm was obtained in the same manner as in Example 2-1, except that the amount of the elastomer resin (a) mixed was changed to 70 parts by mass, and the amount of the polyolefin resin (a) mixed was changed to 30 parts by mass, in Example 2-1. Table 2 shows the evaluation results.

### Example 2-9

A foam sheet having an apparent density after foaming of 0.25 g/cm³ and a thickness of 0.2 mm was obtained in the same manner as in Example 2-6, except that the elastomer resin (b) was used instead of the elastomer resin (a), and the dose of irradiation with the electron beam was changed to 6 Mrad, in Example 2-6. Table 2 shows the evaluation results.

### Example 2-10

A foam sheet having an apparent density after foaming of 0.25 g/cm³ and a thickness of 0.2 mm was obtained in the same manner as in Example 2-7 except that the elastomer resin (b) was used instead of the elastomer resin (a) in Example 2-7. Table 2 shows the evaluation results.

### Example 2-11

A foam sheet having an apparent density after foaming of 0.24 g/cm³ and a thickness of 0.2 mm was obtained in the same manner as in Example 2-7, except that the polyolefin resin (b) was used instead of the polyolefin resin (a), and the dose of irradiation with the electron beam was changed to 2.5 Mrad, in Example 2-7. Table 2 shows the evaluation results.

### Comparative Example 2-1

A foam sheet having an apparent density after foaming of 0.25 g/cm³ and a thickness of 0.2 mm was obtained in the same manner as in Example 2-1, except that 100 parts by mass of only the polyolefin resin (a) was used without using an elastomer resin, and the dose of irradiation with the electron beam was changed to 4 Mrad, in Example 2-1. Table 2 shows the evaluation results. Tg1 was not observed under the measurement conditions of the subject application.

### Comparative Example 2-2

A foam sheet having an apparent density after foaming of 0.25 g/cm³ and a thickness of 0.2 mm was obtained in the same manner as in Example 2-1, except that the amount of the elastomer resin (a) mixed was changed to 10 parts by mass, and the amount of the polyolefin resin (a) mixed was changed to 90 parts by mass, in Example 2-1. Table 2 shows the evaluation results.

### Comparative Example 2-3

100 parts by mass of the elastomer resin (c), 5 parts by mass of the thermally decomposable foaming agent, 1 part by mass of the decomposition temperature adjuster, 0.5 parts by mass of the phenolic antioxidant, 1.8 parts by mass of the crosslinking agent A, and 1.2 parts by mass of the crosslinking agent B were prepared as raw materials. These materials were melt-kneaded and then pressed, to obtain a foam resin sheet having a thickness of 0.38 mm. Both sides of the foam resin sheet obtained were irradiated with 2.5 Mrad of an electron beam at an acceleration voltage of 800 keV, to crosslink the foamable resin sheet. Then, the crosslinked foamable resin sheet was heated to 250° C. to be foamed, to obtain a foam sheet having a density of 0.27 g/cm³ and a thickness of 0.60 mm. Thereafter, stretching was followed, to obtain a foam sheet having an apparent density of 0.27 g/cm³ and a thickness of 0.2 mm. Table 2 shows the evaluation results.

TABLE 2

| | | | | | | | | | | | | | | Comparative | | |
|---|---|---|---|---|---|---|---|---|---|---|---|---|---|---|---|---|
| | | | Example | | | | | | | | | | | Example | | |
| | | | 2-1 | 2-2 | 2-3 | 2-4 | 2-5 | 2-6 | 2-7 | 2-8 | 2-9 | 2-10 | 2-11 | 2-1 | 2-2 | 2-3 |
| Compounding | Elastomer | (a)S1609 | 40 | 40 | 40 | 40 | 40 | 30 | 50 | 70 | | | 50 | | 10 | |
| | (A) | (b)EP1001 | | | | | | | | | 30 | 50 | | | | |
| | | (c)LA3320 | | | | | | | | | | | | | | 100 |
| | Polyolefin | KERNEL | 60 | 60 | 60 | 60 | 60 | 70 | 50 | 30 | 70 | 50 | | 100 | 90 | |
| | resin (B) | KF283 | | | | | | | | | | | | | | |
| | | (b)PP-E- | | | | | | | | | | | 50 | | | |
| | | 333GV | | | | | | | | | | | | | | |
| Physical | Thickness (mm) | | 0.2 | 0.15 | 0.2 | 0.5 | 1.5 | 0.2 | 0.2 | 0.2 | 0.2 | 0.2 | 0.2 | 0.2 | 0.2 | 0.2 |
| properties | Apparent density (g/cm³) | | 0.24 | 0.48 | 0.16 | 0.10 | 0.06 | 0.24 | 0.24 | 0.23 | 0.25 | 0.25 | 0.24 | 0.25 | 0.25 | 0.27 |
| after | Expansion ratio (times) | | 4 | 2 | 6 | 10 | 15 | 4 | 4 | 4 | 4 | 4 | 4 | 4 | 4 | 4 |
| forming | Average cell size (μm) | | 121 | 89 | 142 | 165 | 251 | 79 | 81 | 78 | 72 | 89 | 101 | 95 | 92 | 88 |
| | Tg1(Tg at 0 to 40° C.) | | 15.0 | 15.0 | 15.0 | 15.0 | 15.0 | 14.0 | 16.0 | 18.0 | 24.1 | 26.1 | 18.0 | — | 11.9 | −28.0 |
| | Tg2(Tg at −40° C. | | −119 | −119 | −119 | −119 | −119 | −119 | −119 | −119 | −119 | −119 | 1 | −119 | −119 | — |
| | or less) | | | | | | | | | | | | | | | |
| | tanδ peak value | | 0.49 | 0.49 | 0.49 | 0.49 | 0.49 | 0.38 | 0.61 | 0.82 | 0.81 | 1.29 | 0.62 | — | 0.13 | 1.30 |
| | (with Tg at 0 to 40° C.) | | | | | | | | | | | | | | | |
| | 25% compressive | | 141 | 561 | 75 | 63 | 59 | 133 | 124 | 128 | 113 | 117 | 191 | 124 | 119 | 131 |
| | strength (kPa) | | | | | | | | | | | | | | | |
| | Strength at break (N/10 | | 8.7 | 13.1 | 5.8 | 8.7 | 17.4 | 9.9 | 7.8 | 6.5 | 14.9 | 14.9 | 8.4 | 14.9 | 13.1 | 2.0 |
| | mm) at 23° C. | | | | | | | | | | | | | | | |
| | Elongation at break (%) | | 451 | 471 | 431 | 441 | 461 | 431 | 451 | 461 | 501 | 486 | 431 | 461 | 441 | 521 |
| | at 23° C. | | | | | | | | | | | | | | | |
| | Relative dielectric | | 1.40 | 1.66 | 1.27 | 1.12 | 1.02 | 1.40 | 1.40 | 1.40 | 1.40 | 1.40 | 1.81 | 1.40 | 1.40 | 2.04 |
| | constant | | | | | | | | | | | | | | | |
| | WVTR(g/m2 · day) | | 54.0 | 36.0 | 81.1 | 54.0 | 27.0 | 47.3 | 60.9 | 74.2 | 45.4 | 57.2 | 60.9 | 27.8 | 33.7 | 521.0 |
| | Closed cell ratio (%) | | 99% | 98% | 100% | 99% | 99% | 97% | 100% | 98% | 99% | 98% | 98% | 99% | 98% | 98% |
| | Crosslinking degree (gel | | 51% | 53% | 42% | 54% | 61% | 43% | 40% | 53% | 62% | 40% | 41% | 33% | 45% | 46% |
| | fraction) | | | | | | | | | | | | | | | |
| Evaluation | Vibration | Frequency at | 232 | 232 | 232 | 232 | 232 | 386 | 140 | 51 | 61 | 50 | 51 | — | 1067 | 12500000 |
| | evaluation | tanδ peak | | | | | | | | | | | | | | |
| | | Determination | Good | Good | Good | Good | Good | Good | Good | Good | Good | Good | Good | Poor | Poor | Poor |

| | | | | | | | | | | | | | | |
|---|---|---|---|---|---|---|---|---|---|---|---|---|---|---|
| Moisture test | Good | Good | Good | Good | Good | Good | Good | Good | Good | Good | Good | Good | Good | Poor |

As described above, all of the foam sheets of Examples showed good results in the vibration resistance evaluation and can suppress vibration on the back side, for example, when used in mobile electronic devices such as smartphones. This effect is more exerted particularly when a material such as glass and polycarbonate is used as a backing material.

Meanwhile, since the foam sheets of Comparative Examples do not have a tanδ peak around normal temperature in the vibration resistance evaluation, it can be seen that they do not have a vibration resistance effect.

Further, it can be seen that the foam sheet of the present invention (second invention) has high water vapor permeability, which is a significant advantage over acrylic foams.

### Example 3-1

40 parts by mass of the elastomer resin (a), 60 parts by mass of the polyolefin resin (a), 5 parts by mass of the thermally decomposable foaming agent, 1 part by mass of the decomposition temperature adjuster, and 0.5 parts by mass of the phenolic antioxidant were prepared as raw materials. These materials were melt-kneaded and then pressed, to obtain a foamable resin sheet having a thickness of 0.38 mm. Both sides of the foamable resin sheet obtained were irradiated with 5 Mrad of an electron beam at an acceleration voltage of 500 keV, to crosslink the foamable resin sheet. Then, the crosslinked foamable resin sheet was heated to 250° C. to be foamed, to obtain a foam sheet having an apparent density of 0.24 g/cm³ and a thickness of 0.60 mm. Thereafter, stretching was followed, to obtain a foam sheet having an apparent density of 0.24 g/cm³ and a thickness of 0.2 mm.

Table 3 shows the results of evaluation by the aforementioned method.

### Example 3-2

A foam sheet was obtained in the same manner as in Example 3-1, except that the amount of the thermally decomposable foaming agent was changed to 2.5 parts by mass, and the thickness of the foamable resin sheet was changed to 0.36 mm, in Example 3-1. The apparent density of the foam sheet was 0.48 g/cm^{3,} and the thickness was 0.45 mm. Thereafter, stretching was followed, to obtain a foam sheet having an apparent density of 0.48 g/cm³ and a thickness of 0.15 mm. Table 3 shows the evaluation results.

### Example 3-3

A foam sheet was obtained in the same manner as in Example 3-1, except that the amount of the thermally decomposable foaming agent was changed to 6.5 parts by mass, the thickness of the foamable resin sheet was changed to 0.33 mm, and the dose of irradiation with the electron beam was changed to 4 Mrad, in Example 3-1. The apparent density of the foam sheet was 0.16 g/cm³, and the thickness was 0.60 mm. Thereafter, stretching was followed, to obtain a foam sheet having an apparent density of 0.16 g/cm³ and a thickness of 0.2 mm. Table 3 shows the evaluation results.

### Example 3-4

A foam sheet was obtained in the same manner as in Example 3-1, except that the amount of the thermally decomposable foaming agent was changed to 7 parts by mass, the thickness of the foamable resin sheet was changed to 0.58 mm, and the dose of irradiation with the electron beam was changed to 5.5 Mrad, in Example 3-1. The apparent density of the foam sheet was 0.10 g/cm³, and the thickness was 1.25 mm. Thereafter, stretching was followed, to obtain a foam sheet having an apparent density of 0.10 g/cm³ and a thickness of 0.5 mm. Table 3 shows the evaluation results.

### Example 3-5

A foam sheet was obtained in the same manner as in Example 3-1, except that the amount of the thermally decomposable foaming agent was changed to 9 parts by mass, the thickness of the foamable resin sheet was changed to 0.61 mm, and the dose of irradiation with the electron beam was changed to 6 Mrad, in Example 3-1. The apparent density of the foam sheet was 0.06 g/cm³, and the thickness was 1.5 mm. Table 3 shows the evaluation results.

### Example 3-6

A foam sheet having an apparent density after foaming of 0.24 g/cm³ and a thickness of 0.2 mm to obtain was obtained in the same manner as in Example 3-1, except that the amount of the elastomer resin (a) mixed was changed to 30 parts by mass, the amount of the polyolefin resin (a) mixed was changed to 70 parts by mass, and the dose of irradiation with the electron beam was changed to 4 Mrad, in Example 3-1. Table 3 shows the evaluation results.

### Example 3-7

A foam sheet having an apparent density after foaming of 0.24 g/cm³ and a thickness of 0.2 mm was obtained in the same manner as in Example 3-1, except that the amount of the elastomer resin (a) mixed was changed to 50 parts by mass, the amount of the polyolefin resin (a) mixed was changed to 50 parts by mass, and the dose of irradiation with the electron beam was changed to 4 Mrad, in Example 3-1. Table 3 shows the evaluation results.

### Example 3-8

A foam sheet having an apparent density after foaming of 0.23 g/cm3 and a thickness of 0.2 mm was obtained in the same manner as in Example 3-1, except that the amount of the elastomer resin (a) mixed was changed to 70 parts by mass, and the amount of the polyolefin resin (a) mixed was changed to 30 parts by mass, in Example 3-1. Table 3 shows the evaluation results.

### Example 3-9

A foam sheet having an apparent density after foaming of 0.25 g/cm³ and a thickness of 0.2 mm was obtained in the same manner as in Example 3-6, except that the elastomer resin (b) was used instead of the elastomer resin (a), and the dose of irradiation with the electron beam was changed to 6 Mrad, in Example 3-6. Table 3 shows the evaluation results.

### Example 3-10

A foam sheet having an apparent density after foaming of 0.25 g/cm³ and a thickness of 0.2 mm was obtained in the same manner as in Example 3-7, except that the elastomer resin (b) was used instead of the elastomer resin (a) in Example 3-7. Table 3 shows the evaluation results.

### Example 3-11

A foam sheet having an apparent density after foaming of 0.24 g/cm³ and a thickness of 0.2 mm was obtained in the same manner as in Example 3-7, except that the polyolefin resin (b) was used instead of the polyolefin resin (a), and the dose of irradiation with the electron beam was changed to 2.5 Mrad, in Example 3-7. Table 3 shows the evaluation results.

### Comparative Example 3-1

A foam sheet having an apparent density after foaming of 0.25 g/cm³ and a thickness of 0.2 mm was obtained in the same manner as in Example 3-1, except that 100 parts by mass of only the polyolefin resin (a) was used without using an elastomer resin, and the dose of irradiation with the electron beam was changed to 4 Mrad, in Example 3-1. Table 3 shows the evaluation results. Tg1 was not observed under the measurement conditions of the subject application.

### Comparative Example 3-2

A foam sheet having an apparent density after foaming of 0.25 g/cm³ and a thickness of 0.2 mm was obtained in the same manner as in Example 3-1, except that the amount of the elastomer resin (a) mixed was changed to 10 parts by mass, and the amount of the polyolefin resin (a) mixed was changed to 90 parts by mass, in Example 3-1. Table 3 shows the evaluation results.

### Comparative Example 3-3

100 parts by mass of the elastomer resin (c), 5 parts by mass of the thermally decomposable foaming agent, 1 part by mass of the decomposition temperature adjuster, 0.5 parts by mass of the phenolic antioxidant, 1.8 parts by mass of the crosslinking agent A, and 1.2 parts by mass of the crosslinking agent B were prepared as raw materials. These materials were melt-kneaded and then pressed, to obtain a foam resin sheet having a thickness of 0.38 mm. Both sides of the foam resin sheet obtained were irradiated with 2.5 Mrad of an electron beam at an acceleration voltage of 800 keV, to crosslink the foamable resin sheet. Then, the crosslinked foamable resin sheet was heated to 250° C. to be foamed, to obtain a foam sheet having a density of 0.27 g/cm³ and a thickness of 0.60 mm. Thereafter, stretching was followed, to obtain a foam sheet having an apparent density of 0.27 g/cm³ and a thickness of 0.2 mm. Table 3 shows the evaluation results.

TABLE 3

| | | | | | | | | | | | | | | Comparative | | |
|---|---|---|---|---|---|---|---|---|---|---|---|---|---|---|---|---|
| | | | Example | | | | | | | | | | | Example | | |
| | | | 3-1 | 3-2 | 3-3 | 3-4 | 3-5 | 3-6 | 3-7 | 3-8 | 3-9 | 3-10 | 3-11 | 3-1 | 3-2 | 3-3 |
| Compounding | Elastomer | (a)S1609 | 40 | 40 | 40 | 40 | 40 | 30 | 50 | 70 | | | 50 | | 10 | |
| | (A) | (b)EP1001 | | | | | | | | | 30 | 50 | | | | |
| | | (c)LA3320 | | | | | | | | | | | | | | 100 |
| | Polyolefin | (a) KERNEL | 60 | 60 | 60 | 60 | 60 | 70 | 50 | 30 | 70 | 50 | | 100 | 90 | |
| | resin (B) | KF283 | | | | | | | | | | | | | | |
| | | (b) PP-E- | | | | | | | | | | | 50 | | | |
| | | 333GV | | | | | | | | | | | | | | |
| Physical | Thickness (mm) | | 0.2 | 0.15 | 0.2 | 0.5 | 1.5 | 0.2 | 0.2 | 0.2 | 0.2 | 0.2 | 0.2 | 0.2 | 0.2 | 0.2 |
| properties | Apparent density (g/cm³) | | 0.24 | 0.48 | 0.16 | 0.10 | 0.06 | 0.24 | 0.24 | 0.23 | 0.25 | 0.25 | 0.24 | 0.25 | 0.25 | 0.27 |
| after | Expansion ratio (times) | | 4 | 2 | 6 | 10 | 15 | 4 | 4 | 4 | 4 | 4 | 4 | 4 | 4 | 4 |
| forming | Average cell size (μm) | | 121 | 89 | 142 | 165 | 251 | 79 | 81 | 78 | 72 | 89 | 101 | 95 | 92 | 88 |
| | Tg1(Tg at 0 to 40° C.) | | 15.0 | 15.0 | 15.0 | 15.0 | 15.0 | 14.0 | 16.0 | 18.0 | 24.1 | 26.1 | 18.0 | — | 11.9 | −28.0 |
| | Tg2(Tg at −40° C. or less) | | −119 | −119 | −119 | −119 | −119 | −119 | −119 | −119 | −119 | −119 | 1 | −119 | −119 | — |
| | tanδ peak value | | 0.49 | 0.49 | 0.49 | 0.49 | 0.49 | 0.38 | 0.61 | 0.82 | 0.81 | 1.29 | 0.62 | — | 0.13 | 1.30 |
| | (with Tg at 0 to 40° C.) | | | | | | | | | | | | | | | |
| | 25% compressive strength | | 141 | 561 | 75 | 63 | 59 | 133 | 124 | 128 | 113 | 117 | 191 | 124 | 119 | 131 |
| | Strength at break | | 8.7 | 131 | 5.8 | 8.7 | 17.4 | 9.9 | 7.8 | 6.5 | 14.9 | 14.9 | 8.4 | 14.9 | 13.1 | 2.0 |
| | (N/10 mm) at 23° C. | | | | | | | | | | | | | | | |
| | Elongation at break (%) at | | 451 | 471 | 431 | 441 | 461 | 431 | 451 | 461 | 501 | 486 | 431 | 461 | 441 | 521 |
| | 23° C. | | | | | | | | | | | | | | | |
| | Relative dielectric | | 1.40 | 1.56 | 1.27 | 1.12 | 1.02 | 1.40 | 1.40 | 1.40 | 1.40 | 1.40 | 1.81 | 1.40 | 1.40 | 2.04 |
| | constant | | | | | | | | | | | | | | | |
| | WVTR(g/m2 · day) | | 54.0 | 36.0 | 81.1 | 54.0 | 27.0 | 47.3 | 60.9 | 74.2 | 45.4 | 57.2 | 60.9 | 27.8 | 33.7 | 521.0 |
| | Closed cell ratio (%) | | 99% | 98% | 100% | 99% | 99% | 97% | 100% | 98% | 99% | 98% | 98% | 99% | 98% | 98% |
| | Crosslinking degree (gel | | 51% | 53% | 42% | 54% | 61% | 43% | 40% | 53% | 62% | 40% | 41% | 33% | 45% | 46% |
| | fraction) | | | | | | | | | | | | | | | |
| Evaluation | Vibration | Frequency at | 232 | 232 | 232 | 232 | 232 | 386 | 140 | 51 | 61 | 50 | 51 | — | 1067 | 12500000 |
| | evaluation | tanδ peak | | | | | | | | | | | | | | |
| | | Determination | Good | Good | Good | Good | Good | Good | Good | Good | Good | Good | Good | Poor | Poor | Poor |
| | Radio wave | Delay time | 3.95 | 4.29 | 3.76 | 3.53 | 3.36 | 3.95 | 3.95 | 3.95 | 3.95 | 3.95 | 4.48 | 3.95 | 3.95 | 4.78 |
| | interference | (ns/m) | | | | | | | | | | | | | | |
| | | Determination | Good | Good | Good | Good | Good | Good | Good | Good | Good | Good | Good | Good | Good | Poor |

As described above, all of the foam sheets of Examples showed good results in the vibration resistance evaluation and can suppress vibration on the back side, for example, when used in mobile electronic devices such as smartphones. This effect is more exerted particularly when a material such as glass and polycarbonate is used as a backing material.

Meanwhile, since the foam sheets of Comparative Examples do not have a tanδ peak around normal temperature in the vibration resistance evaluation, it can be seen that they do not have a vibration resistance effect.

Further, the foam sheet of the present invention (third invention) had a short delay time and showed good effects in terms of radio wave interference.

1. A foam sheet having at least one glass transition temperature (Tg1) of 0 to 40° C., a peak value of the loss tangent (tanδ) at the glass transition temperature (Tg1) of 0.30 or more, and a 25% compressive strength of 1000 kPa or less, and further having a glass transition temperature (Tg2) of −40° C. or less.

2. A foam sheet having a glass transition temperature (Tg) of 0 to 40° C., a peak value of the loss tangent (tanδ) of 0.30 or more, a 25% compressive strength of 1000 kPa or less, and a water vapor transmission rate (WVTR) of 400 g/m²·day or less.

3. A foam sheet having at least one glass transition temperature (Tg1) of 0 to 40° C., a peak value of the loss tangent (tanδ) at the glass transition temperature (Tg1) of 0.30 or more, a 25% compressive strength of 1000 kPa or less, and a relative dielectric constant of 2 or less.

4. The foam sheet according to claim 1, having a 25% compressive strength of 800 kPa or less.

5. The foam sheet according to claim 1, having a thickness of 0.03 to 2 mm.

6. The foam sheet according to claim 1, having a strength at break at 23° C. of 5 N/10 mm or more.

7. The foam sheet according to claim 1, having a closed cell ratio of 80% or more.

8. The foam sheet according to claim 1, having an average cell size of 20 to 400 μm.

9. The foam sheet according to claim 1, having a gel fraction of 30 to 80 mass %.

10. The foam sheet according to claim 1, having an apparent density of 0.05 to 0.70 g/cm³.

11. The foam sheet according to claim 1, having a water vapor transmission rate (WVTR) of 400 g/m²·day or less.

12. The foam sheet according to claim 1, having a relative dielectric constant of 2 or less.

13. The foam sheet according to claim 2, having a glass transition temperature (Tg2) present at −40° C. or less.

14. The foam sheet according to claim 1, having an elongation at break at 23° C. of 200% or more.

15. The foam sheet according to claim 1, wherein a resin constituting the foam sheet comprises a polyolefin resin.

16. The foam sheet according to claim 15, wherein the resin constituting the foam sheet further comprises an elastomer.

17. The foam sheet according to claim 16, wherein a mass ratio of the elastomer to the polyolefin resin is 90:10 to 15:85.

18. A pressure-sensitive adhesive tape comprising the foam sheet according to claim 1 and a pressure-sensitive adhesive material provided on at least one surface of the foam sheet.

19. A roll composed of the foam sheet according to claim 1.
